(19) United States
(12) Patent Application Publication
(10) Pub. No.: US 2010/0047622 A1
(43) Pub. Date: Feb. 25, 2010

(54) METAL POWDER

(75) Inventors: Jürgen Fischer, Langelsheim (DE); Aloys Eiling, Bochum (DE); Frank Schrumpf, Goslar (DE); Stefan Zimmermann, Laufenburg (DE); Peter Thienel, Vienenburg (DE); Roland Scholl, Gorwihl (DE)

Correspondence Address: CONNOLLY BOVE LODGE & HUTZ, LLP, P O BOX 2207, WILMINGTON, DE, 19899, US

(73) Assignee: H.C. Starck GmbH, Goslar (DE)

(21) Appl. No.: 12/441,938

(22) PCT Filed: Sep. 21, 2007
(86) PCT No.: PCT/EP2007/060058

§ 371 Date: Oct. 1, 2009

(30) Foreign Application Priority Data
Sep. 22, 2006 (DE) 10 2006 045 481.2

(51) Int. Cl. B32B 9/00; B22F 1/00; C23C 4/06; B22F 3/12; B22F 7/02

(52) U.S. Cl. 428/698; 75/252; 75/254; 427/456; 419/10; 419/5

(57) ABSTRACT

The invention provides for a cermet powder containing
75-90% by weight of at least one hard material powder,
from 10 to 25% by weight of one or more matrix metal powders and
up to 3% by weight of at least one modifier,
   wherein the matrix metal powder or powders contain
from 0 to 38% by weight of cobalt,
from 0 to 38% by weight of nickel,
from 0 to 20% by weight of aluminum,
from 0 to 90% by weight of iron and
from 10 to 35% by weight of chromium and
   the sum of the contents of iron and chromium is in the range from 10 to 95% by weight and the sum of the contents of cobalt, nickel and iron is in the range from 65 to 95% by weight. The invention also relates to a cermet and a process to make the cermet containing the cermet powder and shaped article coated with the cermet powder and a process to make the shaped article.

The invention relates to novel powder mixtures, in particular cermet powders, for the surface coating of metal substrates by thermal spraying processes such as plasma spraying or high-velocity flame spraying (HVOF), flame spraying, electric arc spraying, laser spraying or application welding, for example the PTA process.

Such powders comprise at least one finely divided hard material powder such as WC, Cr₃C₂, TiC, B₄C, TiCN, Mo₂C, etc., and a finely divided metal or alloy matrix powder. Hard material powder and matrix powder are intensively mixed, usually in the presence of a solution of an organic binder, if appropriate with comilling, atomized, dried, sieved and subsequently heated under a hydrogen-containing atmosphere to remove the organic binder and produce a sintered bond so that relatively large agglomerates having a particle size of from 10 to 100 μm are formed.

DE-B2-1446207 discloses a flame spraying powder which contains metal carbides as hard material and from 10 to 45% of aluminum and nickel as metal.

As matrix metal powders, cobalt- and nickel-containing powders, in particular, have become established in the industry.

It is a first object of the invention to reduce the use of cobalt further since cobalt has become a raw material for which demand exceeds supply because of its widespread use.

A further object of the invention is to provide low-cobalt cermet coatings which compared to customary Co—Cr matrix alloys have comparable or increased abrasion resistance and cavitation resistance.

Another object of the invention is to increase the corrosion resistance of cermet coatings, in particular to reduce the solubility of matrix metals from the coatings.

The invention provides cermet powders containing 75-90% by weight of at least one hard material powder and from 10 to 25% by weight of one or more matrix metal powders and also up to 3% by weight of modifiers,

wherein the matrix metal powder or powders contain
from 0 to 38% by weight of cobalt,
from 0 to 38% by weight of nickel,
from 0 to 20% by weight of aluminum,
from 0 to 90% by weight of iron and
from 10 to 35% by weight of chromium and
the sum of the contents of iron and chromium is in the range from 10 to 95% by weight and the sum of the contents of cobalt, nickel and iron is in the range from 65 to 95% by weight.

Advantageous cermet powders are powders which contain 75-90% by weight of at least one hard material powder and from 10 to 25% by weight of one or more matrix metal powders and also up to 3% by weight of modifiers, wherein the matrix metal powder or powders contain up to 38% by weight of cobalt, up to 38% by weight of nickel, up to 20% by weight of aluminum, up to 90% by weight, advantageously up to 75% by weight, of iron and from 20 to 35% by weight of chromium and the sum of the contents of iron and chromium is in the range from 25 to 95% by weight and the sum of the contents of cobalt, nickel and iron is in the range from 65 to 95% by weight, advantageously from 65 to 75% by weight.

Particularly advantageous cermet powders are powders as claimed in claim 1 containing 75-90% by weight of at least one hard material powder and from 10 to 25% by weight of one or more matrix metal powders and also up to 3% by weight of modifiers, wherein the matrix metal powder or powders contain
from 0 to 38% by weight of cobalt,
from 0 to 38% by weight of nickel,
from 0 to 20% by weight of aluminum,
from 0 to 75% by weight of iron and
from 20 to 35% by weight of chromium and

the sum of the contents of iron and chromium is in the range from 25 to 95% by weight and the sum of the contents of cobalt, nickel and iron is in the range from 65 to 75% by weight.

A further embodiment of the invention provides cermet powders containing 75-90% by weight of at least one hard material powder and from 10 to 25% by weight of one or more matrix metal powders and also up to 3% by weight of modifiers,

wherein the matrix metal powder or powders contain
from 0 to 38% by weight of cobalt,
from 0 to 38% by weight of nickel,
from 0 to 20% by weight of aluminum,
from 30 to 90% by weight of iron, advantageously
from 30 to 75% by weight of iron, and
from 10 to 35% by weight of chromium and

the sum of the contents of iron and chromium is in the range from 10 to 95% by weight, advantageously from 60 to 95% by weight, and the sum of the contents of cobalt, nickel and iron is in the range from 65 to 95% by weight.

In preferred cermet powders according to the invention, the matrix metals nickel and cobalt are present in a weight ratio of at least 2:3, more preferably in a weight ratio of 1:1, particularly preferably in a weight ratio of 3:2.

Particularly preferred cermet powders according to the invention are cobalt-free. Further preferred cermet powders are cobalt- and nickel-free.

More preferred, in particular low-cobalt or cobalt-free, cermet powders according to the invention have a content of iron in the matrix metal of at least 30% by weight, with the sum of the contents of iron and chromium in the matrix powder or powders being at least 60% by weight. In such cermet powders, the matrix metal powder or powders contain
from 0 to 10% by weight of cobalt,
from 0 to 38% by weight of nickel,
from 0 to 20% by weight of aluminum,
from 30 to 90% by weight of iron, advantageously
from 30 to 75% by weight of iron, and
from 10 to 35% by weight of chromium.

In cermet powders of the invention, in particular cobalt-free cermet powders of the invention, the ratio of the sum of the contents of chromium and aluminum to the sum of the contents of iron, nickel and chromium in parts by weight is preferably from 1:2.2 to 1:3.7, particularly preferably from 1:2.7 to 1:3.6.

A preferred composition can have from 20 to 26% by weight of chromium, from 64 to 72% by weight of iron and from 5 to 16% by weight of aluminum.

Possible hard material powders are the customary hard material constituents of cermet coatings, e.g. WC, Cr₃C₂, VC, TiC, B₄C, TiCN, SiC, TaC, NbC, Mo₂C and mixtures thereof. Preference is given to WC and Cr₃C₂, in particular WC.

The matrix powders can be produced in a manner known per se by atomization of metal or alloy or part alloy melts. When part alloy powders or metal powders which have not been prealloyed are used, alloying occurs during use (for example during spray application) of the cermet powders.

Preferred cobalt, nickel and/or iron part alloy matrix powders are obtained by chemical precipitation by reaction of appropriate salts with excess oxalic acid, drying and thermal treatment as described in DE 198 22 663 A1 or U.S. Pat. No. 6,554,885 B1, with chromium being mixed in as metal powder.

Possible modifiers are, in particular, steel substrate upgrading elements such as Mo, Nb, Si, W, Ta and/or V.

The matrix metal or matrix alloy powders are preferably free of further constituents apart from tolerable impurities.

The present invention also provides a cermet which has the above-described composition and also a shaped article coated with such a cermet.

To produce these cermet powders, the hard material powder or powders and the matrix powder or powders and also modifiers having, if appropriate, different average particle sizes which should, however, in each case be less than 10 μm in diameter are slurried in a manner known per se in an aqueous solution of an organic binder and homogenized by means of mix-milling in a ball mill, an attritor or a stirred vessel and the suspension is atomized in a spray dryer, with the water evaporating from the sprayed droplets. The resulting powder agglomerate is converted into a powder having an intended particle size by means of classification processes (sieving, sifting) and the organic binder of the agglomerate is released into a hydrogen-containing atmosphere by sintering at a temperature of up to about 1300° C., in particular from 1100° C. to 1300° C. The resulting sinter cake is converted back into powder having the intended particle size range by physical treatment (crushing, milling, sieving, sifting).

A cermet according to the invention can be obtained by pressing and sintering of the cermet powders described or else by thermal spraying, i.e. by means of a thermal spraying process such as high-velocity flame spraying, cold gas spraying, plasma spraying or similar processes. The present invention therefore likewise provides a process for producing a cermet or an article having the above-described composition, which comprises the steps:
providing a powder as claimed in one or more of claims 1 to 11 in a form or preparation which is suitable for thermal spraying;
carrying out a thermal spraying process using this powder;
obtaining the cermet or the article.

The present invention therefore likewise provides a process for producing a cermet or an article having the above-described composition, which comprises the steps:
providing a powder as claimed in one or more of claims 1 to 11;
shaping the powder under pressure to give a green body;
heating the green body to give the cermet or the article.

### EXAMPLES 1 TO 7

A tungsten carbide powder having a particle size of 0.9 μm determined by FSSS, a carbon content of 6.1% by weight and a content of free carbon of 0.05% by weight was used in each case.

The matrix powder 1 (table 1) of examples 1 to 5 having the composition indicated there was produced by chemical precipitation using a method analogous to example 2 of DE 198 22 663 A1. The particle size was 1.4-2.2 μm FSSS at a specific surface area determined by the BET method of 1.8-2.6 m²/g. The matrix powder 2 of examples 1 to 3 is an electrolytically produced powder having a particle size D50 of 3.1 μm (laser light scattering).

The matrix metal powder of examples 6 and 7 was obtained by atomization of an alloy melt of Fe, Cr and Al. The particle size D90 was 10.8 and 10.2 μm, respectively (laser light scattering).

About 50 kg of cermet powder composed of WC and matrix alloys of the composition shown in table 1 were introduced into an initial charge of 10 l of water containing about 1% of polyvinyl alcohol (PVA, Shin-Etsu, GP05) as binder and about 0.5% of Nalco (Deutsche Nalco GmbH) as wetting agent and homogenized by means of a ball mill, the homogenized suspension was atomized in a commercial spray dryer and the water was evaporated from the spray droplets. The agglomerated powder obtained in this way is subjected to a thermal treatment and the bond is thereby converted into a sintered bond. The sintered cake obtained in this way is converted into powder in the intended particle size range by crushing, milling, sieving and sifting. The carbon content, the average particle size determined by laser light scattering, the particle size distribution and the bulk density of the cermet powders are reported in table 1.

TABLE 1

| | | Example No. | | | | | | |
|---|---|---|---|---|---|---|---|---|
| | | 1 | 2 | 3 | 4 | 5 | 6 | 7 |
| WC | % by | 86 | 86 | 86 | 88 | 83 | 88 | 88 |
| | weight | | | | | | | |
| Matrix | % by | 10 | 10 | 10 | 12 | 17 | 12 | 12 |
| powder 1 | weight | | | | | | | |
| Co content | Parts | 5 | 1 | 0 | 2.4 | 0 | 0 | 0 |
| | by | | | | | | | |
| | weight | | | | | | | |
| Ni content | Parts | 5 | 2 | 5 | 4.8 | 3.1 | 0 | 0 |
| | by | | | | | | | |
| | weight | | | | | | | |
| Fe content | Parts | 0 | 7 | 5 | 4.8 | 13.9 | 8.5 | 8 |
| | by | | | | | | | |
| | weight | | | | | | | |
| Cr content | Parts | 0 | 0 | 0 | 0 | 0 | 2.75 | 3 |
| | by | | | | | | | |
| | weight | | | | | | | |
| Al content | Parts | 0 | 0 | 0 | 0 | 0 | 0.75 | 1 |
| | by | | | | | | | |
| | weight | | | | | | | |
| Matrix | % by | 4 | 4 | 4 | 0 | 0 | 0 | 0 |
| powder 2: Cr | weight | | | | | | | |
| Cermet powder: | | | | | | | | |
| C content | % by | 5.49 | 5.4 | 5.5 | 5.43 | 5.15 | 5.78 | 5.82 |
| | weight | | | | | | | |
| Sintering | ° C. | 1140 | 1150 | 1160 | 1150 | 1150 | 1140 | 1140 |
| temperature | | | | | | | | |
| Average | μm | 35.3 | 34.4 | 33.6 | 35.8 | 36.4 | 28.1 | 26.5 |
| particle | | | | | | | | |
| size | | | | | | | | |
| D90% | μm | 57.1 | 56.7 | 55.4 | 57.9 | 57.7 | 44.8 | 43.2 |
| D50% | μm | 33.7 | 32.5 | 31.6 | 34.1 | 35.1 | 25.7 | 24.6 |
| D10% | μm | 18.4 | 17.3 | 17.0 | 18.3 | 19.5 | 13.6 | 13.0 |
| Bulk density | g/cm³ | 4.22 | 4.11 | 4.15 | 3.93 | 3.95 | 3.92 | 3.96 |

Coatings on building steel ST37 were produced from the powders by means of high-velocity flame spraying (HVOF system Diamond Jet Hydrid 2600).

Table 2 reports the properties of the coatings.

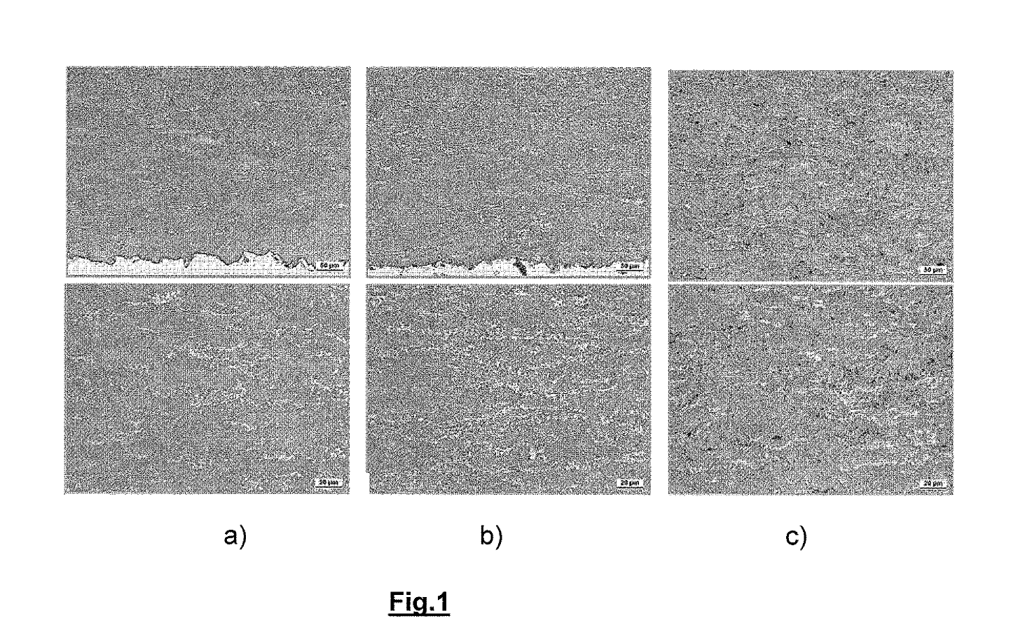

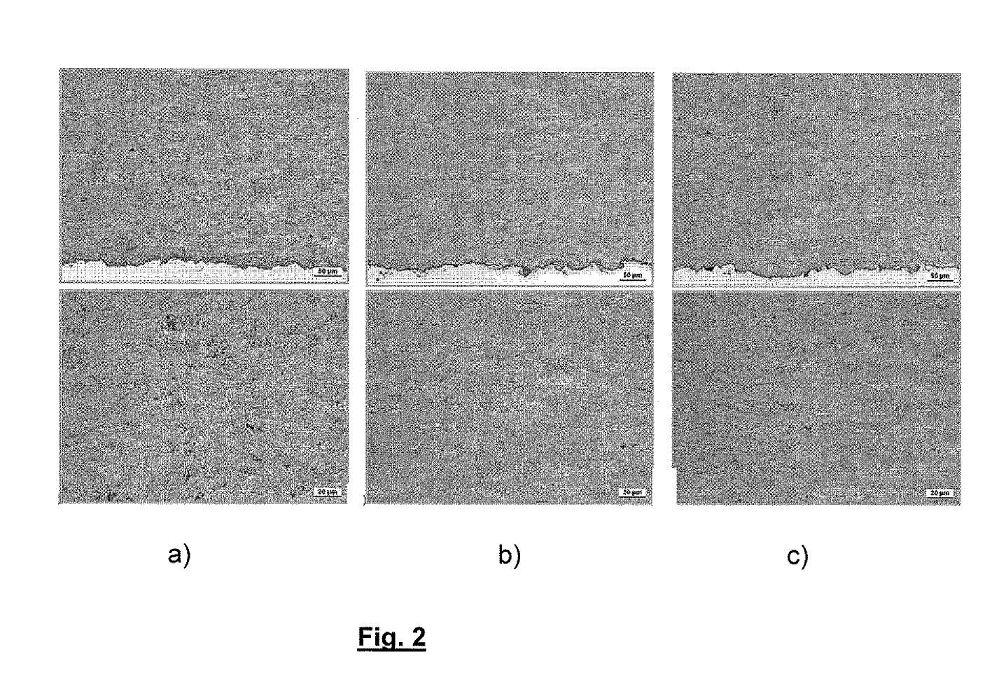

FIG. 1 shows optical micrographs of the microstructure of the coatings produced using the powders from examples 1 (FIG. 1a)), 2 (FIG. 1b)) and 3 (FIG. 1c)). FIG. 2 shows optical micrographs of the microstructure of the coatings produced using the powder from example 7 and using the spray parameters “standard” (FIG. 2a)), “cold and fast” (FIG. 2b)) and “hot and slow” (FIG. 2c)), respectively.

TABLE 2

| | | Powder from example | | | | |
|---|---|---|---|---|---|---|
| | | 1 | 2 | 3 | 6 | 7 |
| Surface | | | | | | |
| roughness | | | | | | |
| Ra | μm | 3.9 | 3.33 | 3.88 | 3.74 | 3.65 |
| Rz | μm | 22.44 | 21.05 | 22.49 | 21.52 | 20.52 |
| Hardness HV | | 1388 ± 82 | 1275 ± 117 | 1329 ± 90 | 1386 ± 112 | 1393 ± 139 |
| 0.3¹⁾ | | | | | | |
| Cavitation | mg/h | 3.3 ± 0.5 | 4.7 ± 0.9 | 4.7 ± 0.7 | 6.1 ± 1.8 | 6.3 ± 2.2 |
| rate²⁾ | | | | | | |
| Wear³⁾ | mg | 33.5 | 33.5 | 23.3 | 18.1 | 17.8 |
| O content | % by | 0.30 | 0.47 | 0.37 | 0.68 | 0.75 |
| | weight | | | | | |
| C content | % by | 4.42 | 4.23 | 4.29 | 4.68 | 4.70 |
| | weight | | | | | |
| C loss | % by | 19 | 22 | 22 | 19 | 19 |
| | weight | | | | | |
| Corrosion | | ++ | ++ | + | +++ | +++ |
| resistance/ | | | | | | |
| salt spray | | | | | | |
| test | | | | | | |

¹⁾in accordance with DIN EN ISO 6507
²⁾in accordance with ASTM G 32
³⁾in accordance with ASTM G65

1-18. (canceled)

19. A cermet powder comprising
75-90% by weight of at least one hard material powder,
from 10 to 25% by weight of one or more matrix metal powders and
up to 3% by weight of at least one modifier,
wherein the matrix metal powder or powders contain
from 0 to 38% by weight of cobalt,
from 0 to 38% by weight of nickel,
from 0 to 20% by weight of aluminum,
from 0 to 90% by weight of iron and
from 10 to 35% by weight of chromium and
the sum of the contents of iron and chromium is in the range from 10 to 95% by weight and the sum of the contents of cobalt, nickel and iron is in the range from 65 to 95% by weight.

20. The cermet powder as claimed in claim 19, which comprises
from 75-90% by weight of at least one hard material powder,
from 10 to 25% by weight of one or more matrix metal powders and
up to 3% by weight of modifiers,
wherein the matrix metal powder or powders contain
from 0 to 38% by weight of cobalt,
from 0 to 38% by weight of nickel,
from 0 to 20% by weight of aluminum,
from 0 to 75% by weight of iron and
from 20 to 35% by weight of chromium and
the sum of the contents of iron and chromium is in the range from 25 to 95% by weight and the sum of the contents of cobalt, nickel and iron is in the range from 65 to 75% by weight.

21. The cermet powder as claimed in claim 19, wherein the matrix metal powder contains from 0 to 75% by weight of iron.

22. The cermet powder as claimed in claims 19, wherein the sum of the contents of cobalt, nickel and iron is in the range from 65 to 75% by weight.

23. The cermet powder as claimed in claim 19, wherein the nickel and cobalt are present in the matrix powder or powders in a weight ratio of at least 2:3.

24. The cermet powder as claimed in claim 19, wherein the matrix powder or powders are cobalt-free.

25. The cermet powder as claimed in claim 19, wherein the matrix powder or powders are cobalt- and nickel-free.

26. The cermet powder as claimed in claim 19, wherein the content of iron in the matrix powder or powders is at least 30% by weight.

27. The cermet powder as claimed in claim 19, wherein the sum of the contents of iron and chromium of the matrix powder or powders is at least 60% by weight.

28. The cermet powder as claimed in claim 19, wherein the ratio of the sum of the contents of chromium and aluminum to the sum of the contents of iron, nickel and chromium in parts by weight is from 1:2.2 to 1:3.7.

29. The cermet powder as claimed in claim 19, wherein the matrix powder has the composition: from 20 to 26% by weight of chromium, from 64 to 72% by weight of iron and from 5 to 16% by weight of aluminum.

30. The cermet powder as claimed in claim 19, wherein the hard material powder is a powder selected from the group consisting of WC, Cr₃C₂, VC, TiC, B₄C, TiCN, SiC, TaC, NbC, Mo₂C and mixtures thereof.

31. The cermet powder as claimed in claim 19, wherein the modifier is selected from the group consisting of Mo, Nb, Si, W, Ta, V and mixtures thereof.

32. A process for coating a surface with comprises thermal spray coating the surface with the powder as claimed in claim 19.

33. A cermet having the composition as claimed in claim 19.

34. A shaped article which has a coating comprising the cermet as claimed in claim 33.

35. A process for producing the cermet as claimed in claim 33 which comprises
providing a powder in a form or preparation which is suitable for thermal spraying;
carrying out a thermal spraying process using this powder;
obtaining the cermet and
wherein the powder comprises
75-90% by weight of at least one hard material powder,
from 10 to 25% by weight of one or more matrix metal powders and
up to 3% by weight of at least one modifier,
wherein the matrix metal powder or powders contain
from 0 to 38% by weight of cobalt,
from 0 to 38% by weight of nickel,
from 0 to 20% by weight of aluminum,
from 0 to 90% by weight of iron and
from 10 to 35% by weight of chromium and
the sum of the contents of iron and chromium is in the range from 10 to 95% by weight and the sum of the contents of cobalt, nickel and iron is in the range from 65 to 95% by weight.

36. A process for producing the shaped article as claimed in claim 34 which comprises
providing a powder in a form or preparation which is suitable for thermal spraying;
carrying out a thermal spraying process using this powder;
obtaining the article and
wherein the powder comprises
75-90% by weight of at least one hard material powder,
from 10 to 25% by weight of one or more matrix metal powders and
up to 3% by weight of at least one modifier,
wherein the matrix metal powder or powders contain
from 0 to 38% by weight of cobalt,
from 0 to 38% by weight of nickel,
from 0 to 20% by weight of aluminum,
from 0 to 90% by weight of iron and
from 10 to 35% by weight of chromium and
the sum of the contents of iron and chromium is in the range from 10 to 95% by weight and the sum of the contents of cobalt, nickel and iron is in the range from 65 to 95% by weight.

37. A process for producing the cermet as claimed in claim 33, which comprises
providing a powder;
shaping the powder under pressure to give a green body;
heating the green body to give the cermet and
wherein the powder comprises
75-90% by weight of at least one hard material powder,
from 10 to 25% by weight of one or more matrix metal powders and
up to 3% by weight of at least one modifier,
wherein the matrix metal powder or powders contain
from 0 to 38% by weight of cobalt,
from 0 to 38% by weight of nickel,
from 0 to 20% by weight of aluminum,
from 0 to 90% by weight of iron and
from 10 to 35% by weight of chromium and
the sum of the contents of iron and chromium is in the range from 10 to 95% by weight and the sum of the contents of cobalt, nickel and iron is in the range from 65 to 95% by weight.

38. A process for producing the article as claimed in claim 34, which comprises the steps:
providing a powder;
shaping the powder under pressure to give a green body;
heating the green body to give the article and
wherein the powder comprises
75-90% by weight of at least one hard material powder,
from 10 to 25% by weight of one or more matrix metal powders and
up to 3% by weight of at least one modifier,
wherein the matrix metal powder or powders contain
from 0 to 38% by weight of cobalt,
from 0 to 38% by weight of nickel,
from 0 to 20% by weight of aluminum,
from 0 to 90% by weight of iron and
from 10 to 35% by weight of chromium and
the sum of the contents of iron and chromium is in the range from 10 to 95% by weight and the sum of the contents of cobalt, nickel and iron is in the range from 65 to 95% by weight. 671774 1 10
